(19) United States
(12) Patent Application Publication
(10) Pub. No.: US 2017/0228646 A1
(43) Pub. Date: Aug. 10, 2017

(54) SPIKING MULTI-LAYER PERCEPTRON

(71) Applicant: QUALCOMM Incorporated, San Diego, CA (US)

(72) Inventors: Peter O'CONNOR, Amsterdam (NL); Max WELLING, Amsterdam (NL)

(21) Appl. No.: 15/252,151

(22) Filed: Aug. 30, 2016

Related U.S. Application Data
(60) Provisional application No. 62/291,409, filed on Feb. 4, 2016.

(51) Int. Cl. G06N 3/08; G06F 11/07

(52) U.S. Cl. CPC G06N 3/084; G06F 11/079; G06F 11/0721

(57) ABSTRACT

A method of training a neural network with back propagation includes generating error events representing a gradient of a cost function for the neural network. The error events may be generated based on a forward pass through the neural network resulting from input events, weights of the neural network and events from a target signal. The method further includes updating the weights of the neural network based on the error events.

### CROSS-REFERENCE TO RELATED APPLICATION

The present application claims the benefit of U.S. Provisional Patent Application No. 62/291,409, filed on Feb. 4, 2016, and titled “SPIKING MULTI-LAYER PERCEPTRON,” the disclosure of which is expressly incorporated by reference herein in its entirety.

### BACKGROUND

Field

Certain aspects of the present disclosure generally relate to machine learning and, more particularly, to improving systems and methods of configuring and training a spiking multilayer perceptron.

Background

An artificial neural network, which may comprise an interconnected group of artificial neurons (e.g., neuron models), is a computational device or represents a method to be performed by a computational device.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Deep learning architectures are layered neural networks architectures in which the output of a first layer of neurons becomes an input to a second layer of neurons, the output of a second layer of neurons becomes and input to a third layer of neurons, and so on. Deep neural networks may be trained to recognize a hierarchy of features and so they have increasingly been used in object recognition applications. Like convolutional neural networks, computation in these deep learning architectures may be distributed over a population of processing nodes, which may be configured in one or more computational chains.

In the standard application of a deep network to a supervised-learning task, an input vector may be supplied through multiple hidden layers, to produce a prediction, which is in turn compared to some target value to find a scalar cost. Parameters of the network are then updated according to their derivatives with respect to that cost. This approach provides that all modules within the network are differentiable (otherwise, no gradient can flow through them, and backpropagation may not work).

One type of artificial neural network is a spiking neural network. In spiking neural networks, units communicate by sending events to one another. Such events are generally called “spikes” because, in biological spiking networks, the voltage trace of a neuron's membrane potential that identifies one of these events resembles a sharp “spike”.

Unfortunately, training such spiking neural network is difficult. That is, it is challenging to back propagate an error signal through a spiking network, because the spiking network outputs are discrete events, rather than smoothly differentiable functions of the input.

### SUMMARY

In an aspect of the present disclosure, a method of training a neural network with back propagation is presented. The method includes generating error events representing a gradient of a cost function for the neural network. The error events are generated based on a forward pass through the neural network resulting from input events, weights of the neural network and events from a target signal. The method also includes updating the weights of the neural network based on the error events.

In another aspect of the present disclosure, an apparatus for training a neural network with back propagation is presented. The apparatus includes a memory and at least one processor coupled to the memory. The one or more processors are configured to generate error events representing a gradient of a cost function for the neural network. The error events are generated based on a forward pass through the neural network resulting from input events, weights of the neural network and events from a target signal. The processor(s) is(are) also configured to update the weights of the neural network based on the error events.

In yet another aspect of the present disclosure an apparatus for training a neural network with back propagation is presented. The apparatus includes means for generating error events representing a gradient of a cost function for the neural network. The error events are generated based on a forward pass through the neural network resulting from input events, weights of the neural network and events from a target signal. The apparatus also includes means for updating the weights of the neural network based on the error events.

In still another aspect of the present disclosure, a non-transitory computer-readable medium is presented. The non-transitory computer-readable medium has encoded thereon program code for training a neural network with back propagation. The program code is executed by a processor and includes program code to generate error events representing a gradient of a cost function for the neural network. The error events are generated based on a forward pass through the neural network resulting from input events, weights of the neural network and events from a target signal. The program code further includes program code to update the weights of the neural network based on the error events.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 is a block diagram illustrating an exemplary architecture of a spiking multi-layer perceptron in accordance with aspects of the present disclosure.

FIG. 7 illustrates a method for training a spiking neural network according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Aspects of the present disclosure are directed to the application of deep learning online, to systems with multiple streaming sensory inputs. One example of this is in mobile robotics. Currently, the problem of learning and inference in mobile robotics has a number of characteristics that make it inefficient to use regular deep-learning approaches. For example, multiple sensors may send information at varying rates. In a vector-based system, this scenario may call for development of a scheme with which to update various parts of the model in response to different events.

A second exemplary inefficiency is with respect to tight power constraints due to battery limitations. The standard deep learning pipeline, which involves passing arrays of floating-point numbers through multiple layers of representation, regardless of their contents, is inherently wasteful. This is because the amount of computation does not depend on the amount of information that is actually in the data.

Furthermore, in vector-based deep networks, the entire model is generally updated in a single step. As such, it is difficult to apply such models in a setting with streaming input data coming in from multiple sensors at different rates.

In view of these inefficiencies, it is desirable to provide a system that communicates with “spikes” such that “expected” data requires less computation in training. It is also desirable to reduce or possibly eliminate the use of multiplication operations. Furthermore, it is desirable to provide a system in which the computational cost of a single update scales with layer-size rather than layer-size squared. That is, it is desirable to provide a system that breaks down the function of a deep network into a series of computationally inexpensive updates, such that the network can make predictions before having seen the full data sample. Furthermore, it is desirable to provide a system that may be used for both training and testing.

Accordingly, aspects of the present disclosure are directed to configuring and operating a spiking multi-layer perceptron. The spiking multi-layer perceptron (SMLP) is an event-based architecture in which computations are conducted when the units (e.g., computational units such as neurons) send events (e.g., spikes) to one another. In some exemplary aspects, an event may comprise data communicated between two units. When unit i sends a spike, it increments the potential of each downstream unit j in proportion to the synaptic weight W_{i,j} connecting the units. If this increment brings unit j's potential past some threshold, unit j will send a spike to its downstream units. In some aspects, a spike may comprise a type of event wherein the unit that fired indicates its address. A signed spike may comprise a type of event wherein the unit that fired communicates its address, and the sign {−1,+1} of the given event.

The amount of computation performed in a given iteration therefore depends on the contents of the input data and the network's success in predicting the target. In some aspects, the SMLP may be used for learning based on streaming event-based data, and has useful applications in low power systems or systems that call for a low response latency. Further, the SMLP may be applied to a conventional classification problem (e.g., Mixed National Institute of Standards and Technology (MNIST) database). Furthermore, the SMLP may also be used for processing event-based sensor data.

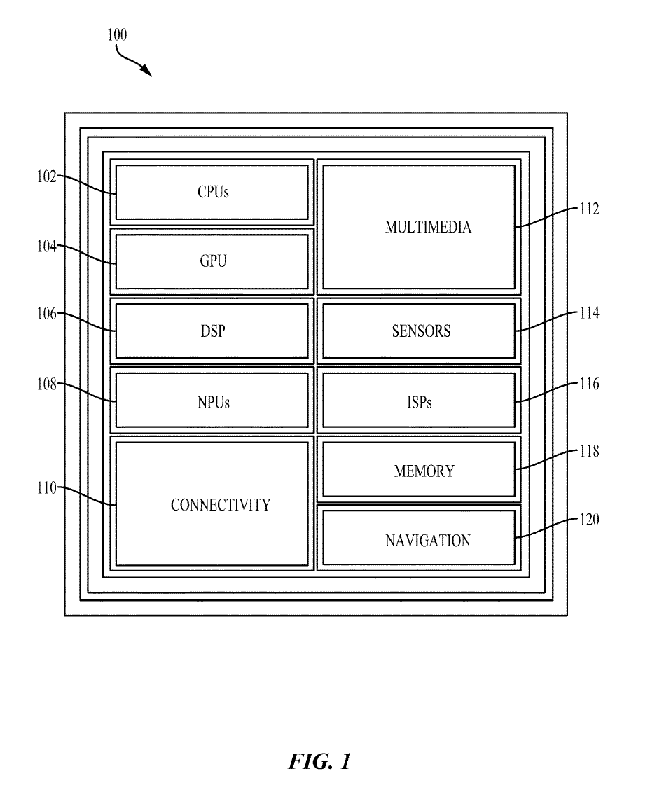

FIG. 1 illustrates an example implementation of the aforementioned spiking multi-layer perceptron using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for receiving an input vector. The instructions loaded into the general-purpose processor 102 may also comprise code for generating error events representing a gradient of a cost function for the neural network based on a forward pass through the neural network resulting from input events, weights of the neural network and events from a target signal. The instructions loaded into the general-purpose processor 102 may further comprise code for updating weights of the neural network based on the error events.

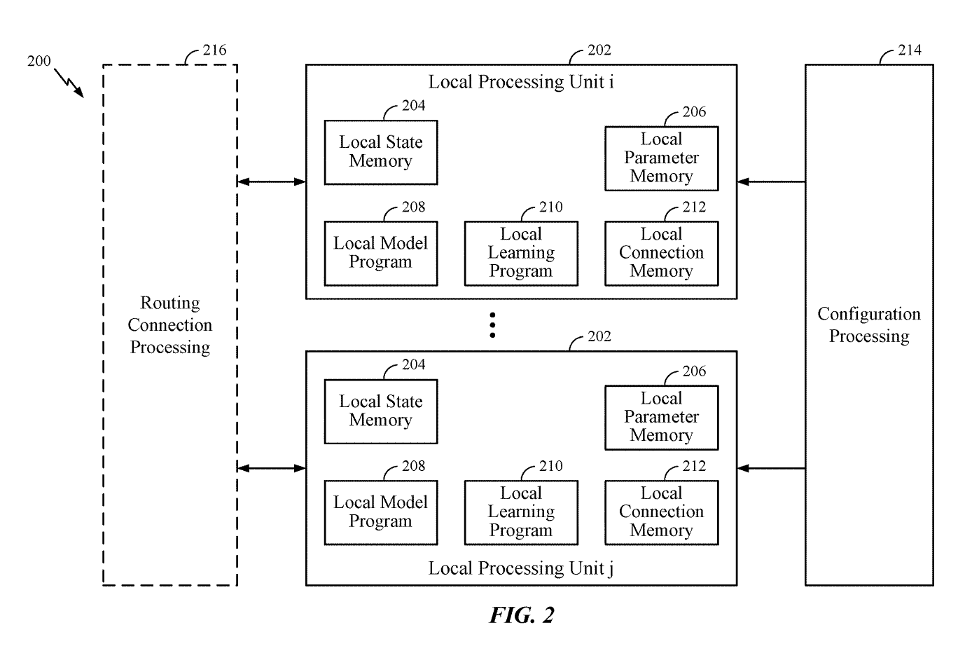

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

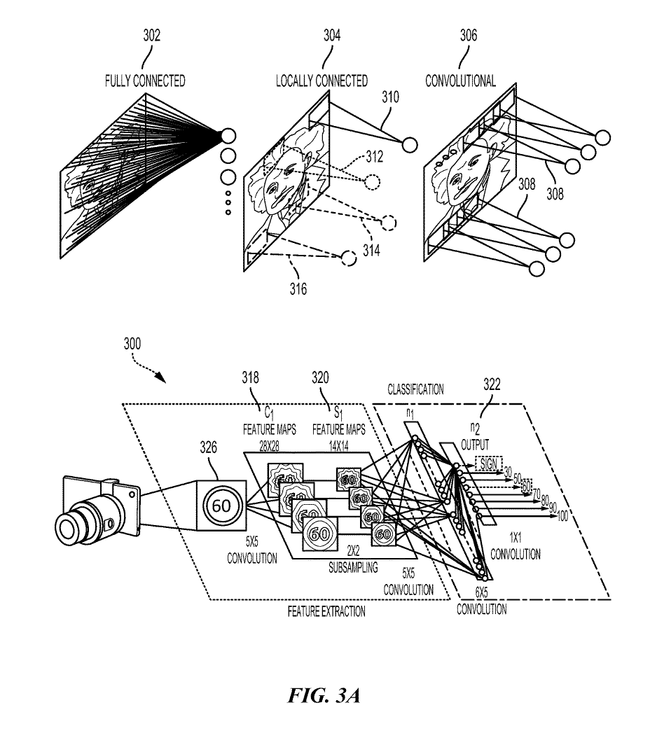

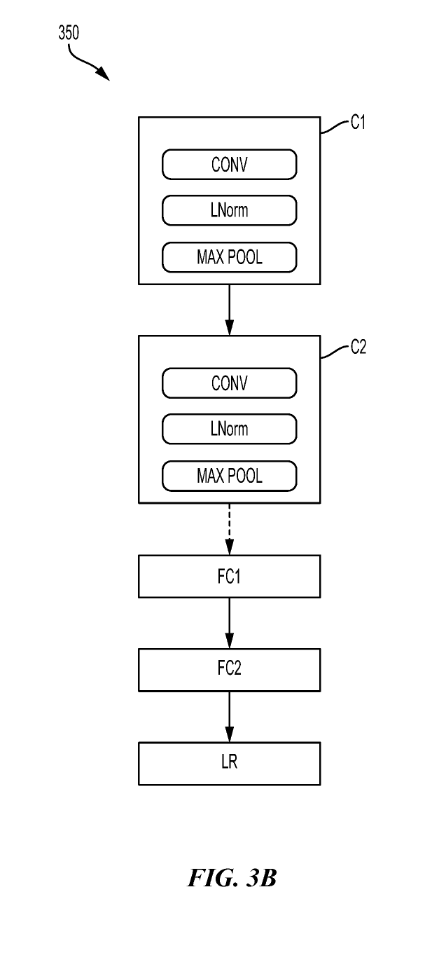

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the neural network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

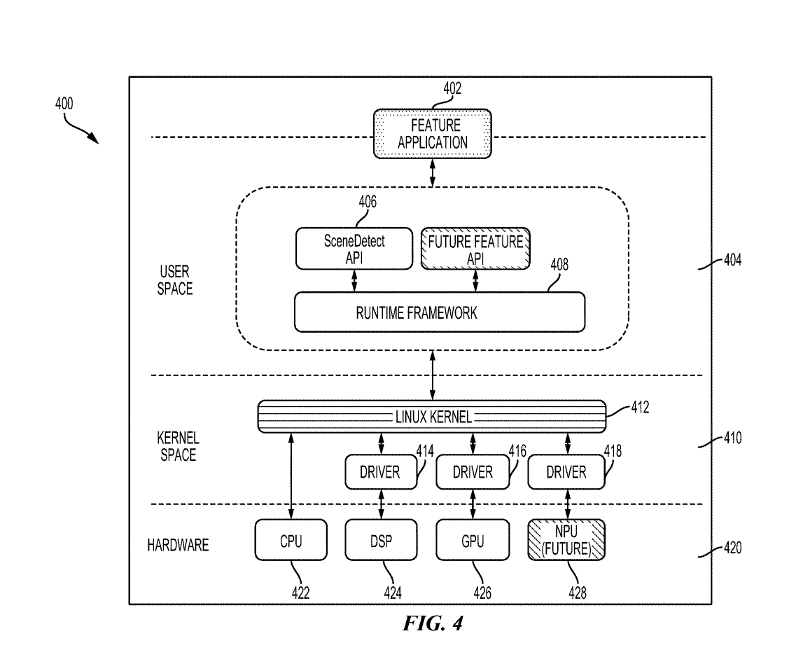

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

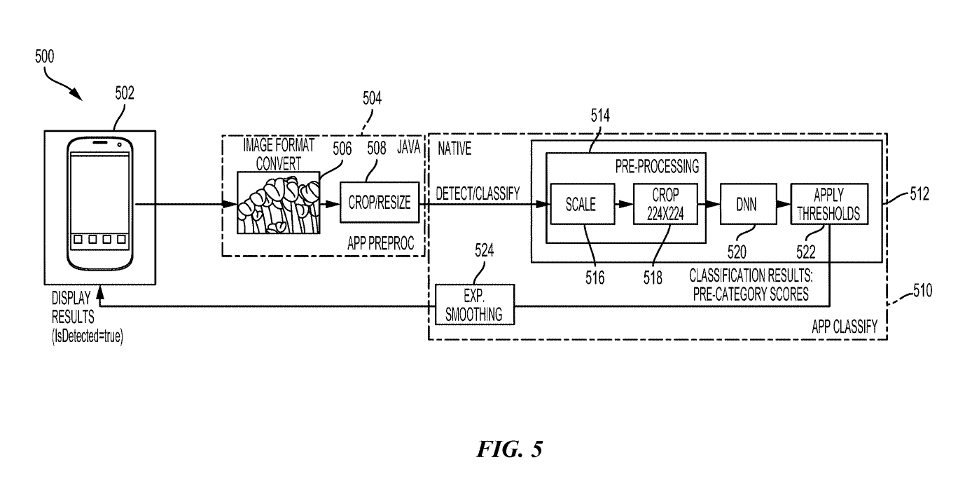

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

### Spiking Multi-Layer Perceptron

Aspects of the present disclosure are directed to a deep spiking network that may, for example, be trained online. Unlike conventional implementations, in which networks are trained using a conventional training approach and then mapped to an event-based network, the network of the present disclosure may be trained in an event-based manner, in which backpropagation is implemented with spikes.

As discussed above, spiking neural networks include units (e.g., artificial neurons) that communicate by sending events to one another. In some aspects, the units may comprise a leaky integrate-and-fire (LIF) neuron, for example. Such events are generally called “spikes” because, in biological spiking networks, the voltage trace of a neuron's membrane potential that identifies one of these events resembles a sharp “spike”.

There are a variety of different types of spiking neural networks, varying from biologically realistic to abstract computational models. Spiking neural networks may, for example, be implemented as a dynamical system defined by differential equations. In dynamical-type spiking neural networks, a time-step may be selected as a tradeoff between faithfulness or consistency of a continuous system and computational cost associated with solving multiple differential equations.

Spiking neural networks may also be implemented as event-based systems. In such systems, the state of a neuron may be computed only upon the arrival of an input event to that neuron. As such, the amount of computation may depend on the contents of the data (because the number of events generated, and therefore the computational time, are functions of the contents of the input data vector).

In accordance with aspects of the present disclosure, a variable-spike quantization process may be used to generate events, for example, when the input is a vector. The events or spikes may comprise an approximation of an input vector \vec{v}. For example, a real vector, \vec{v}, may be approximated by a series of “signed spikes”:

$$\vec{v} \approx \frac{1}{T} {\sum }_{n = 1}^{N} {e}_{{i}_{n}}^{\to } {s}_{n}$$

where T represents the total number of time bins, iₙ is the index of the unit from which the n'th spike fires, eᵢ_{ₙ}^{→}is a one-hot encoded vector with index iₙ set to one (1), and sₙε(−1,1) is a sign of the n'th spike.

In this process, an internal state vector \vec{Ø} may be maintained. The state Øᵢ of a unit, is decremented by one every time a spike is emitted. The unit emits spikes until its state Øᵢ is in the interval bounded by

$$( - \frac{1}{2} , \frac{1}{2} ) .$$

Because

$$∀ i : - \frac{1}{2} < {∅}_{i} < \frac{1}{2} ,$$

the L1 norm is bounded by:

$${‖ {∅}_{T} ‖}_{L 1} = {‖ {\sum }_{t = 1}^{T} v - {\sum }_{n = 1}^{N} {e}_{{i}_{n}} {s}_{n} ‖}_{L 1} < 0.5 * l ( \vec{v} ) \qquad ( 1 )$$

where l(\vec{v}) is the number of elements in vector \vec{v}.

Taking the limit of infinite time, the spikes converge to form an approximation of \vec{v}:

$${lim}_{T \to ∞} : \frac{1}{T} {‖ {∅}_{T} ‖}_{L 1} = 0 \\ {lim}_{T \to ∞} : ‖ \frac{1}{T} {\sum }_{t = 1}^{T} v - \frac{1}{T} {\sum }_{n = 1}^{N} {e}_{{i}_{n}}^{\to } {s}_{n} ‖ L 1 = 0 \\ {lim}_{T \to ∞} : \vec{v} = \frac{1}{T} {\sum }_{n = 1}^{N} {e}_{{i}_{n}}^{\to } {s}_{n} \qquad ( 2 )$$

Accordingly, the process may perform a discrete-time, bidirectional form of delta-sigma modulation in which floating point elements of vector \vec{v} may be encoded as a stream of events (e.g., spikes) or in some cases, a stream of signed events.

The sequence of input events may be sampled. Exemplary pseudocode for sampling the events as a single vector is provided below in Table 1:

TABLE 1

| | |
|---|---|
| 1: | Input: vector \vec{ν} and int T |
| 2: | for t ∈ 1 . . . T do |
| 3: | \vec{} ← \vec{} + \vec{ν} |
| 4: | while True do |
| 5: | i ← argmax(\|\vec{}\|) |
| 6: | $if \vert {\vec{∅}}_{i} \vert > \frac{1}{2} then$ |
| 7: | s ← sign(\|\vec{}\|ᵢ) |
| 8: | \vec{} ᵢ ← \vec{} ᵢ − s |
| 9: | FireSignedSpike(source = i, sign = s) |
| 10: | else |
| 11: | break |

In Table 1, a sequence of signed-spikes may be drawn from a vector. A priority queue may be used to efficiently send spikes from units for which the state Øᵢ were highest first. In some aspects, the order of spikes may depend on an arbitrary index of the unit. Notably, in accordance with aspects of the present disclosure, sampling could be implemented in parallel without regard to the order of events within a single time step t. Instead, each unit (e.g., neuron) may emit an event and decrement its state \vec{Ø}ᵢ by s until its |\vec{Ø}ᵢ| is below ½. As shown in the exemplary pseudo code of Table 1, the FireSignedSpike procedure sends the address of the unit that fired (source), and the sign associated with the firing event (s), to the units connected downstream. This may, in some respects, provide a “deterministic sampling” of the vector v.

### Quantizing Vector Streams

In some aspects, a stream of vectors may be represented as a stream of events. If instead of a fixed vector \vec{v}, a stream of vectors vₛₜᵣₑₐₘ={\vec{v}₁, . . . \vec{v}_{T}} is received as an input, the quantization process may be modified to increment 0 by vₜ on timestep t. With a vector stream, Equation 2 may be modified as follows:

$$\begin{matrix}{lim}_{T \to ∞} : \vec{v} = \frac{1}{T} {‖ {\sum }_{t = 1}^{T} {v}_{t}^{\to } - {\sum }_{n = 1}^{N} {e}_{{i}_{n}}^{\to } {s}_{n} ‖}_{L 1} = 0 & ( 3 ) \\ {lim}_{T \to ∞} : \frac{1}{T} {\sum }_{t = 1}^{T} \vec{{v}_{t}} = \frac{1}{T} {\sum }_{n = 1}^{N} {e}_{{i}_{n}}^{\to } {s}_{n} & ( 4 )\end{matrix}$$

As such, the running mean of the stream of vectors vₛₜᵣₑₐₘ may be approximated.

### Incremental Dot Product

In some aspects, the quantization methods may also be used to incrementally compute the dot product of a vector and a matrix. For instance, take a vector \vec{u} defined as:

\vec{u}←\vec{v}·W (5)

where W is a matrix of parameters (e.g., weight). If a stream of events V stream approximating \vec{v} is extracted, the stream may be passed through W to get a new stream of events that approximates \vec{u}:

$$\hat{u} = \frac{1}{T} {\sum }_{n = 1}^{N} {s}_{n} \cdot {\vec{W}}_{{i}_{n} ,} : \qquad ( 6 )$$

where W_{i,:} is the i'th row of matrix W.

### Quantization and Rectification

In some aspects, the event stream may be rectified on an event-basis. For example, the units (e.g., neurons) may be configured to fire or output events only on positive threshold-crossings. Table 2 illustrates exemplary pseudo code for rectifying the event stream.

TABLE 2
Drawing a sequence of positive spikes from a stream of vectors.

| | |
|---|---|
| 1: | procedure RECTIFY QUANTICIZE STREAM (stream) |
| 2: | for vₜ^{→} ∈ stream do |
| 3: | \vec{} ← \vec{} + vₜ^{→} |
| 4: | while True do |
| 5: | i ← argmax(\|\vec{}\|) |
| 6: | $if ( {\vec{∅}}_{i} ) > \frac{1}{2} then$ |
| 7: | \vec{} ᵢ ← \vec{} ᵢ − 1 |
| 8: | FireSpike(source = i) |
| 9: | else |
| 10: | break |

As shown in Table 2, for each element j with potential Øⱼ, the rectification process decrements the potential until

$${∅}_{j} < \frac{1}{2} .$$

As shown in me exemplary pseudo code of Table 2, a FireSpike procedure sends the address of the unit that just fired to any downstream units for further processing. In some aspects, the rectification process may be configured to increment the threshold for emitting the next spike instead of decrementing Øⱼ.

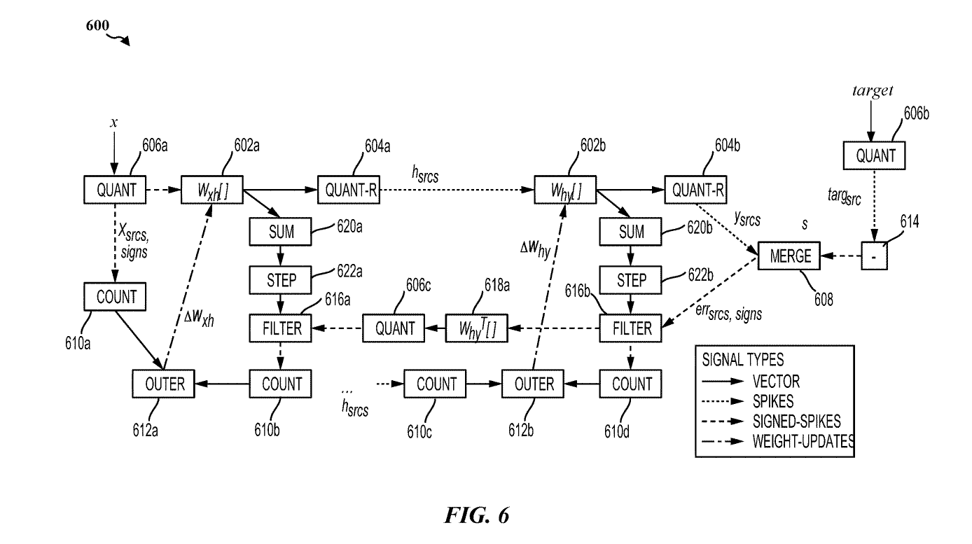

FIG. 6 is a block diagram illustrating an exemplary architecture of a spiking multi-layer perceptron (SMLP) 600 in accordance with aspects of the present disclosure. Referring to FIG. 6, the SMLP 600 includes a forward pass and a backward pass.

### Forward Pass

The forward pass consists of alternating layers of weight modules (e.g., 602a, 602b) and quantifier-rectifier modules (quant-rect) (e.g., 604a, 604b). A forward pass may, in some aspects, be considered processing of an input event via the layers of the SMLP to compute an output event. An input x may be received in the forward pass. The input x may, for example, comprise a vector or a stream of events. Where the input x is a vector, the input may be quantized (e.g., via quantizer 606a) as described above to generate an event or sequence of events. When the input x is in the form of an event, the input event may be processed by passing the input event to the alternating layers of weight modules (e.g., 602a, 602b) and quantifier-rectifier modules (e.g., 604a, 604b) of the forward pass to generate an output event y. The output event y may be compared to a target event (target) or expected value from a training data set. In some aspects, if the target is a vector, the target may also be quantized (e.g., via quantizer 606b) as described above to generate the target event or sequence of target events.

### Backward Pass

In the backward pass, error events or spikes may be supplied as feedback to determine the weight gradients and to update the neural network. The error events may be computed based on both the events from the target signal and the network output. In other words, error events may include events that arrive at the end of the network from the target (targ_{src}). In one example, the error events may be computed according to the mean squared error cost (e.g., C=½ (y−target)² and the Error=dC/dy=(y−target)). The “error spikes” for the top layer may comprise the spikes from the output layer “merged” or joined via a merge module 608 in a single stream with the negated target spikes. The single stream may be referred to as the “error signal” (e.g., dC/dy). In some aspects, the SMLP may be configured without the merge module 608. In this aspect, the output event (e.g., y_{srcs}) and the target event (target_{src}) may be supplied to the difference module 614 (shown as “−”).

In some aspects, in the backward pass, units may send signed spikes (error events), while in a forward pass, the units may send spikes. By sending signed error events in the backward pass, the weights of the units may more efficiently be adjusted.

Additionally, in some aspects, the SMLP 600 may be configured with filter modules (e.g., 616a, 616b) that block spikes on all units for which the cumulative sum (e.g., computed via sum modules (620a,620b)) into the corresponding quantization layer is less than zero. The error signed-spike that is output from a filter module (e.g., 616a, 616b) of a layer may be used to index columns of that layer's weight matrix (e.g., using transposed weight module 618a), and in some aspects, may negate the value if the sign of the spike is negative. The resulting vector may then be supplied into the error quantization module (e.g., 606c), which in turn sends error events or spikes back to the previous layers.

The count modules (e.g., 610a, 610b, 610c, 610d) may maintain a histogram of the error events and sources normalized by time. The source events output via weight modules (e.g., 602a, 602b) may be summed via respective sum modules (e.g., 620a, 620b) at each time step (e.g., defined via step modules 622a, 622b). The “outer” modules (e.g., 612a, 612b) may collect the input/error spike statistics, and feed changes back to the weight matrices (e.g., via weight modules 602a, 602b).

In operation, the SMLP may, for example be supplied an image as an input x. The image may be decomposed into a stream of events. At each time step t, the input units may send their spikes into the SMLP. A target spike, whose address corresponds to the class of the input image (e.g., “cat”), may also be supplied. The target spike may be merged with the spikes output via the network (e.g., forward pass). The combined signal (corresponding to an error) may be back propagated through the network.

In a stochastic gradient descent (SGD) mode, (non-fractional, described with respect to FIG. 6) this process may be repeated until a time step T, at which point, the input spikes and error spikes for each weight may be counted (e.g., via count modules 610a, 610b). The count of the input spikes and the error spikes may be used to determine an approximation to the gradient. For a given weight matrix W_{L}, this is the outer product of the per-input-unit input spike count vector c_{L-1} and the per-output-unit error spike count-vector e_{L} (e.g., computed via outer module 612a, 612b). This approximation to the gradient may be used to update the weights.

In a fractional SGD-mode, weight updates may be performed on every time-step t from 1 to T. As such, the SMLP may be operated without the count module for error events (shown as 610d). The count module for input events (shown as 610c) remains. The “outer” module (e.g., 612a, 612b) shown in FIG. 6 may be replaced by a “fractional update” module (not shown). Accordingly, in one example, every time an error spike arrives (e.g., unit j in layer L), the count-vector of input events in the previous layer (c_{L-1}) may be multiplied by the sign of the error-spike and used to update the j'th column of the weight matrix W_{L}.

When an error signed-spike is fed back into a weight-matrix, the column corresponding to the spike may be multiplied by the sign of the error spike. This product may then be supplied and added to the cumulative sum. As such, some errors may cancel out over the duration of a single training run. Accordingly, fewer error spikes may be propagated back to lower layers, and in turn, fewer computations are performed. Thus, power consumption may be reduced and computational efficiency may be improved.

### Weight Updates

Each weight module (e.g., 602a, 602b) may have an associated weight update module (not shown). In some aspects, the weights of the neural network may be updated using fractional stochastic gradient descent (FSGD). That is, incremental weight updates may be performed. With event-based processing, weight updates may be performed whenever an error event is sent via the backward pass. The error events may represent a gradient of a cost function (e.g., derivative of cost with respect to a hidden node) for the neural network based on a forward pass through the neural network. The forward pass results from input events, weights of the neural network, and events from a target signal.

The updates may be sent to a column of the weight matrix every time an error event comes in as given by:

$$Δ {W}_{: , i} ← - \frac{η}{T} \cdot s \cdot {c}_{in}^{\to } \qquad ( 7 )$$

where c_{\vec{in}} is an integer vector of counted input spikes, ΔW_{:,1} is the change to the i'th column of the weight matrix, sε(−1, 1) is the sign of the error event, i is the index of the unit that produced that error event and T is the number of time-steps per training iteration.

Fractional stochastic gradient descent may help to avoid overshooting in learning. Because the value of the weight is updated with every new error event, fewer error events may be sent back once the weight matrix adjusts to correct the error. In addition, early input events may contribute to more weight updates than input events near the end of the training iteration. The additional influence given to earlier input events may cause the network to learn to make better predictions more quickly.

Alternatively, in some aspects, the weights may be trained using stochastic gradient descent. In this case, two or more vectors, c_{\vec{in}} and c_{\vec{ou}t} may be collected. The outer product of these vectors at the end of a training iteration may be used to compute the weight update as given by:

$$Δ W ← - \frac{η}{T} \cdot {c}_{in}^{\to } ⊗ {c}_{out}^{\to } \qquad ( 8 )$$

That is, the weight update may be conducted by measuring the events that are output from a layer and recording the error events. The error events may be summed at the end of a training iteration and used to compute the weight update.

Accordingly, in view of the foregoing, aspects of the present disclosure provide numerous advantages over conventional systems. For example, the neural networks of the present disclosure may have a number of potential computational advantages over conventional deep networks. One advantage may be with respect to the efficiency with which updates may be performed. In event-based neural networks (e.g., a spiking neural network), the basic messaging entity is a spike. When a new spike arrives at the input, the cost of the resulting update depends on the source of the spike and the current state of the network. If a spike, on average, causes one spike in each downstream layer of the network, the average cost will be O(Nₘₐₓ), where Nₘₐₓ is the number of units in the widest layer. Compare this to a standard network, where the basic messaging entity is a vector. When a vector arrives at the input, the cost of update will be O((k_{L-1}·N_{L})ₘₐₓ), where (N_{L-1}·N_{L})ₘₐₓ is the maximum product between the sizes of two successive layers. Thus, the event-based approaches of the present disclosure may be beneficial in real-time applications, where a single spike may carry an important piece of information to be processed quickly and thus low-latency is desirable.

Aspects of the present disclosure may also provide hardware implementation efficiency. Currently, the bulk of computation in deep learning consists of matrix multiplications and convolutions between arrays of floating-point numbers. The event based neural networks of the present disclosure may be designed to run without multiplication, and thus may be implemented more efficiently.

Furthermore, as mentioned previously, in an event-based system the amount of computation to be performed depends on the contents of the data. It is intuitive that when a training example is expected, it should perform less computation than when it is unexpected and new information is learned. However, conventional deep-network implementations may spend the same amount of computation whether the network's prediction was close to the target or not. Conversely, in accordance with aspects of the present disclosure, training iterations with correct predictions perform less computation than those with incorrect predictions.

In one configuration, a machine learning model is configured for generating error events representing a gradient of a cost function for the neural network. The machine learning model is also configured for updating weights of the neural network based on the error events. The model includes generating means and/or updating means. In one aspect, the generating means and/or updating means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

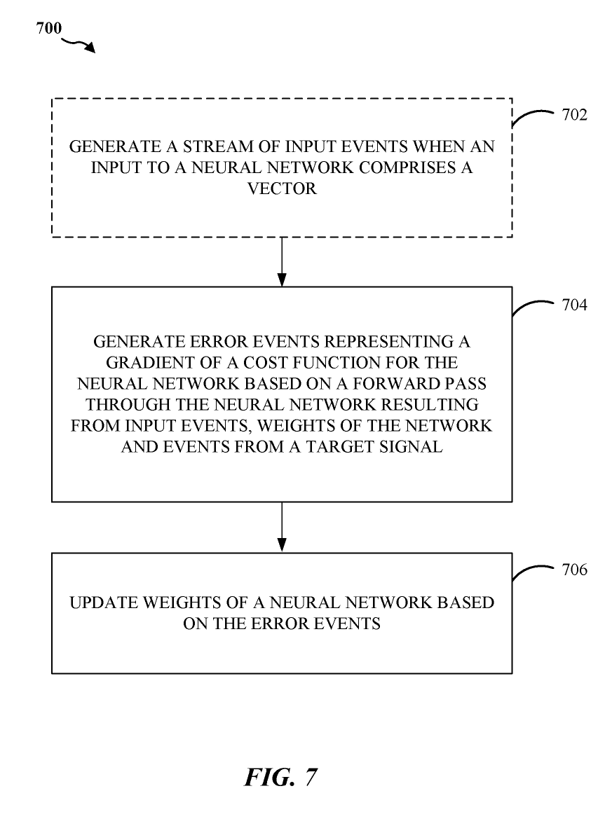

FIG. 7 illustrates a method 700 for training a spiking neural network. The spiking neural network may comprise layers of neurons or other computational units. The neurons may be connected via synaptic connections. Initially the method may optionally generate one or more input events if an input to the neural network comprises a vector, in block 702.

In block 704, the process generates error events. The error events may represent a gradient of a cost function (e.g., derivative of cost with respect to hidden node) for the neural network based on a forward pass through the neural network resulting from input events, weights of the neural network and events from a target signal. In some aspects, the cost function may comprise the mean squared error. The cost function may be minimized by adjusting the network.

The input event may comprise sensory inputs, for example, from a mobile robot. The events may comprise spikes, which in some aspects, may be signed spikes including both positive spikes and negative spikes. Further, a layer may be configured to only emit positive spikes such that it approximates a rectified version of the input vector (e.g., the sequence of events includes only positive spikes).

In block 706, the process updates weights of the neural network based on the error events. The weights may be updated at the end of a training iteration or, in some aspects, the weights may be updated incrementally. That is, the weights of the spiking neural network may be updated based on a single error event.

In some aspects, the process may be configured to operate the neural network on an event basis. For instance, the process may generate output events via the forward pass through the neural network such that the output events are generated at timings based on an occurrence of a predefined event (a positive threshold crossing of the membrane potential for a neuron).

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

In some aspects, method 700 may be performed by the SOC 100 (FIG. 1), the system 200 (FIG. 2), the SOC 420 (FIG. 4), or the smartphone 502 (FIG. 5). That is, each of the elements of method 700 may, for example, but without limitation, be performed by the SOC 100, the system 200, the SOC 420 or one or more processors (e.g., CPU 102, local processing unit 202 or CPU 422) and/or other components included therein.

According to the present disclosure, a process performs back propagation on a spiking network. The network is “spiking” in the sense that neurons accumulate their activation into a potential over time, and send a signal when the potential crosses a threshold and the neuron is reset. Neurons update their state when receiving signals from other neurons. Total computation of the network thus scales with frequency of neuron activation rather than network size. The spiking multi-layer perceptron behaves similarly to a conventional deep network of rectified linear units. A spiking version of back propagation can train the network.

The present disclosure enables early guessing about a class associated with a stream of input events, even before all data has been presented to the network. Moreover, addition, comparison and index operations are employed. Multiplication and floating point numbers are avoided, making the solution amendable to efficient hardware implementation.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of training a neural network with back propagation, comprising:
generating error events representing a gradient of a cost function for the neural network based on a forward pass through the neural network resulting from input events, weights of the neural network and events from a target signal; and
updating the weights of the neural network based on the error events.

2. The method of claim 1, in which the weights of the neural network are updated based on a single error event.

3. The method of claim 1, in which the input events comprise signed spikes.

4. The method of claim 1, in which the input events includes only positive spikes.

5. The method of claim 1, further comprising:
receiving an input vector; and
generating the input events corresponding to the input vector.

6. The method of claim 1, further comprising generating output events via the forward pass through the neural network, the output events generated at timings based on an occurrence of a predefined event.

7. The method of claim 1, in which the error events are generated based on a computed error and a mean squared error cost.

8. An apparatus for training a neural network with back propagation, comprising:
a memory; and
at least one processor coupled to the memory, the at least one processor configured:
to generate error events representing a gradient of a cost function for the neural network based on a forward pass through the neural network resulting from input events, weights of the neural network and events from a target signal; and
to update the weights of the neural network based on the error events.

9. The apparatus of claim 8, in which the at least one processor is further configured to update the weights of the neural network based on a single error event.

10. The apparatus of claim 8, in which the input events comprise signed spikes.

11. The apparatus of claim 8, in which the input events includes only positive spikes.

12. The apparatus of claim 8, in which the at least one processor is further configured:
to receive an input vector; and
to generate the input events corresponding to the input vector.

13. The apparatus of claim 8, in which the at least one processor is further configured to process the input events via the forward pass through the neural network to generate output events at timings based on an occurrence of a predefined event.

14. The apparatus of claim 8, in which the at least one processor is further configured to generate the error events based on a computed error and a mean squared error cost.

15. An apparatus for training a neural network with back propagation, comprising:
means for generating error events representing a gradient of a cost function for the neural network based on a forward pass through the neural network resulting from input events, weights of the neural network and events from a target signal; and
means for updating the weights of the neural network based on the error events.

16. The apparatus of claim 15, in which the weights of the neural network are updated based on a single error event.

17. The apparatus of claim 15, in which the input events comprise signed spikes.

18. The apparatus of claim 15, in which the input events includes only positive spikes.

19. The apparatus of claim 15, further comprising:
means for receiving an input vector; and
means for generating the input events corresponding to the input vector.

20. The apparatus of claim 15, further comprising means for generating output events via the forward pass through the neural network at timings based on an occurrence of a predefined event.

21. The apparatus of claim 15, in which the error events are generated based on a computed error and a mean squared error cost.

22. A non-transitory computer-readable medium having encoded thereon program code for training a neural network with back propagation, the program code being executed by a processor and comprising:
program code to generate error events representing a gradient of a cost function for the neural network based on a forward pass through the neural network resulting from input events, weights of the neural network and events from a target signal; and
program code to update the weights of the neural network based on the error events.

23. The non-transitory computer-readable medium of claim 22, further comprising program code to update the weights of the neural network based on a single error event.

24. The non-transitory computer-readable medium of claim 22, in which the input events comprise signed spikes.

25. The non-transitory computer-readable medium of claim 22, in which the input events includes only positive spikes.

26. The non-transitory computer-readable medium of claim 22, further comprising:
program code to receive an input vector; and
program code to generate the input events corresponding to the input vector.

27. The non-transitory computer-readable medium of claim 22, in which the forward pass through the neural network generates an output event at timings based on an occurrence of a predefined event.

28. The non-transitory computer-readable medium of claim 22, in which the error events are generated based on a computed error and a mean squared error cost.
